(19) United States
(12) Patent Application Publication
(10) Pub. No.: US 2021/0356807 A1
(43) Pub. Date: Nov. 18, 2021

(54) LIQUID CRYSTAL DISPLAY PANEL

(71) Applicant: Shenzhen China Star Optoelectronics Technology Co., Ltd., Shenzhen, Guangdong (CN)

(72) Inventors: Houbin Li, Shenzhen, Guangdong (CN); Chingfu Chien, Shenzhen, Guangdong (CN)

(21) Appl. No.: 16/604,372

(22) PCT Filed: Apr. 28, 2019
(86) PCT No.: PCT/CN2019/084795

§ 371 Date: Oct. 10, 2019

(30) Foreign Application Priority Data
Apr. 8, 2019 (CN) 201910276133.4

(51) Int. Cl. G02F 1/1335; G02F 1/1339

(52) U.S. Cl. CPC G02F 1/133514; G02F 1/13394; G02F 1/133512

(57) ABSTRACT

A liquid crystal display panel includes an array substrate, a color filter substrate, a liquid crystal layer, and a spacer. The array substrate is disposed at a bottom of the liquid crystal display panel. The color filter substrate is disposed above the liquid crystal panel. The liquid crystal layer is disposed between the array substrate and the color filter substrate. The spacer is disposed between the array substrate and the color filter substrate and the spacer is configured to support the array substrate and the color filter substrate. The color filter substrate is provided with at least one semi-transparent region configured to shield from light leakage when two sides of the array substrate are shifted, which reduces an aperture ratio of the liquid crystal display panel and a loss ratio of the liquid crystal display panel.

### BACKGROUND OF INVENTION

### Field of Invention

The present invention relates to a field of display, and more particular, to a liquid crystal display panel.

### Description of Prior Art

With development of thin film transistor-liquid crystal display (TFT-LCD) technology, keeping costs down and improving manufacturing process are achieved and thus flat panel display devices have been focused in the display technology field. The TFT-LCD is made by assembling a color film substrate and an array substrate.

A color filter substrate is provided with a color filter and a black matrix. Light mainly passes through the color filter of TFT-LCD to emit colored light, and the black matrix is mainly used to shield from light leakage of pixels. The color filter substrate and the array substrate are assembled. When the liquid crystal display panel is subjected to a large pressure, the color filter substrate and the array substrate are shifted, and a position of the black matrix is also shifted, which fails to play a shielding role and results in light leakage.

Conventionally, when the liquid crystal display panel is subjected to pressure, the array substrate and the color filter substrate are easily to be shifted, which causes a light leakage problem. Therefore, an improvement is urgently needed.

### SUMMARY OF INVENTION

The present invention relates to a liquid crystal display panel for solving the problem that the color filter substrate and the array substrate are easily to be shifted when the display panel is subjected to pressure, which causes a light leakage problem.

To solve the above problems, the technical solution provided by the present application is as follows.

In one embodiment, a liquid crystal display panel includes an array substrate, a color filter substrate, a liquid crystal layer, a spacer, and a spacer pad. The array substrate is disposed at a bottom of the liquid crystal display panel, and the color filter substrate corresponds to the array substrate and is disposed above the liquid crystal panel, and the liquid crystal layer is disposed between the array substrate and the color filter substrate. The spacer is also disposed between the array substrate and the color filter substrate and the spacer is configured to support the array substrate and the color filter substrate. The color filter substrate is provided with at least one semi-transparent region configured to shield from light leakage when two sides of the array substrate are shifted, which reduces an aperture ratio of the liquid crystal display panel and a loss ratio of the liquid crystal display panel.

In one embodiment, the liquid crystal panel includes a color filter and a black matrix disposed on the color filter substrate.

In one embodiment, the color filter comprises a red color filter, a green color filter, and a blue color filter.

In one embodiment, the at least one semi-transparent region is disposed between the red color filter and the black matrix, between the green color filter and the black matrix, and between the blue color filter and the black matrix.

In one embodiment, the at least one semi-transparent region is exposed within the black matrix using a gray tone mask or a half tone mask.

In one embodiment, the liquid crystal display panel further includes a sealant.

In one embodiment, the sealant is disposed between the array substrate and the color filter substrate, outside the liquid crystal layer, and a periphery of the liquid crystal display panel.

In one embodiment, the spacer pad is disposed under the spacer and above the array substrate.

In one embodiment, a liquid crystal display panel includes an array substrate, a color filter substrate, a liquid crystal layer, and a spacer. The array substrate is disposed at a bottom of the liquid crystal display panel, and the color filter substrate corresponds to the array substrate and is disposed above the liquid crystal panel, and the liquid crystal layer is disposed between the array substrate and the color filter substrate. The spacer is also disposed between the array substrate and the color filter substrate configured to support the array substrate and the color filter substrate. The color filter substrate is provided with at least one semi-transparent region configured to shield from light leakage when two sides of the array substrate are shifted, which reduces an aperture ratio of the liquid crystal display panel and a loss ratio of the liquid crystal display panel.

In one embodiment, a color filter and a black matrix disposed on the color filter substrate.

In one embodiment, the color filter comprises a red color filter, a green color filter, and a blue color filter.

In one embodiment, the at least one semi-transparent region is disposed between the red color filter and the black matrix, between the green color filter and the black matrix, and between the blue color filter and the black matrix.

In one embodiment, the at least one semi-transparent region is exposed within the black matrix using a gray tone mask or a half tone mask.

In one embodiment, the at least one semi-transparent region includes a first semi-transparent region, a second semi-transparent region, a third semi-transparent region, a fourth semi-transparent region, a fifth semi-transparent region, a sixth semi-transparent region, a seventh semi-transparent region, an eighth semi-transparent region, a ninth semi-transparent region, a tenth region semitransparent, an eleventh semi-transparent region, and a twelfth semi-transparent region.

In one embodiment, the first semi-transparent region corresponds to the second semi-transparent region, the third semi-transparent region corresponds to the fourth semi-transparent region, the fifth semi-transparent region corresponds to the sixth semi-transparent region, the seventh semi-transparent region corresponds to the eighth semi-transparent region, the ninth semi-transparent region corresponds to the tenth semi-transparent region, and the eleventh semi-transparent region corresponds to the twelfth semi-transparent region.

In one embodiment, lengths, widths, and heights of the first semi-transparent region, the second semi-transparent region, the fifth semi-transparent region, the sixth semi-transparent region, the ninth semi-transparent region, and the tenth semi-transparent region are same, and lengths, widths, and heights of the third semi-transparent region, the fourth semi-transparent region, the seventh semi-transparent region, the eighth semi-transparent region, the eleventh semi-transparent region, and the twelfth semi-transparent region are same.

In one embodiment, a thickness of the at least one semi-transparent region is less than a thickness of the black matrix, and a width of the at least one semi-transparent region is greater than, less than, or equal to a width of the black matrix.

In one embodiment, a part between the black matrix and the at least one semi-transparent region is at a round angle or a right angle.

In one embodiment, a method of manufacturing a liquid crystal display panel for improving moire includes following steps:

S10, providing a color filter substrate;

S20, attaching a plurality of color filters to the color filter substrate;

S30, forming a black matrix between two adjacent color filters; and

S40, forming at least one semi-transparent region at an edge of the black matrix.

In one embodiment, the two adjacent color filters have different colors.

Compared to the prior art, the liquid crystal display panel provided is provided with at least one semi-transparent region between the black matrix and the color filter on the color filter substrate. When the liquid crystal display panel is subjected to a large pressure, the at least one semi-transparent region is configured to shield from light leakage when two sides of the array substrate are shifted, which reduces an aperture ratio of the liquid crystal display panel and a loss ratio of the liquid crystal display panel.

### BRIEF DESCRIPTION OF DRAWINGS

In order to clearly illustrate the technical solutions in the embodiments of the present invention, the drawings used in the description of the embodiments will be briefly described below. It is obvious that the drawings in the following description are only some embodiments of the present invention. Other drawings can also be obtained from those skilled in the art based on the drawings without paying any creative effort.

FIG. 1 is a schematic view of a liquid crystal display panel according to one embodiment.

FIG. 2 is a first structural schematic view of a color filter substrate of a liquid crystal display panel according to one embodiment.

FIG. 3 is a second structural schematic view of a color filter substrate of a liquid crystal display panel according to one embodiment.

FIG. 4 is a schematic flowchart of a method of manufacturing a liquid crystal display panel for improving moire according to one embodiment.

### DETAILED DESCRIPTION OF PREFERRED EMBODIMENTS

The technical solutions in the embodiments will be clearly and completely described in the following with accompanying drawings. It is apparent that embodiments are only a part of the embodiments of the present invention, and not all of them. Other embodiments obtained by a person skilled in the art based on the embodiments without creative efforts are within the scope of the present invention.

The following description of the embodiments is provided by reference to the following drawings. Directional terms mentioned in this application, such as “center,” “longitudinal,” “transverse,” “length,” “width,” “thickness,” “up,” “down,” “forward,” “backward,” “left,” “right,” “vertical,” “horizontal,” “top,” “bottom,” “inside,” “outside,” “clockwise,” “counterclockwise” etc., are merely indicated the direction of the drawings and are not to be construed as limiting the scope of the present invention. Moreover, the terms “first” and “second” are used for descriptive purposes and are not to be construed as indicating or implying a relative importance or implicitly indicating the number of technical features. Thus, “first” or “second” may include one or more of the described features either explicitly or implicitly. In the description of the present invention, the meaning of “a plurality” means two or more unless otherwise specifically defined herein.

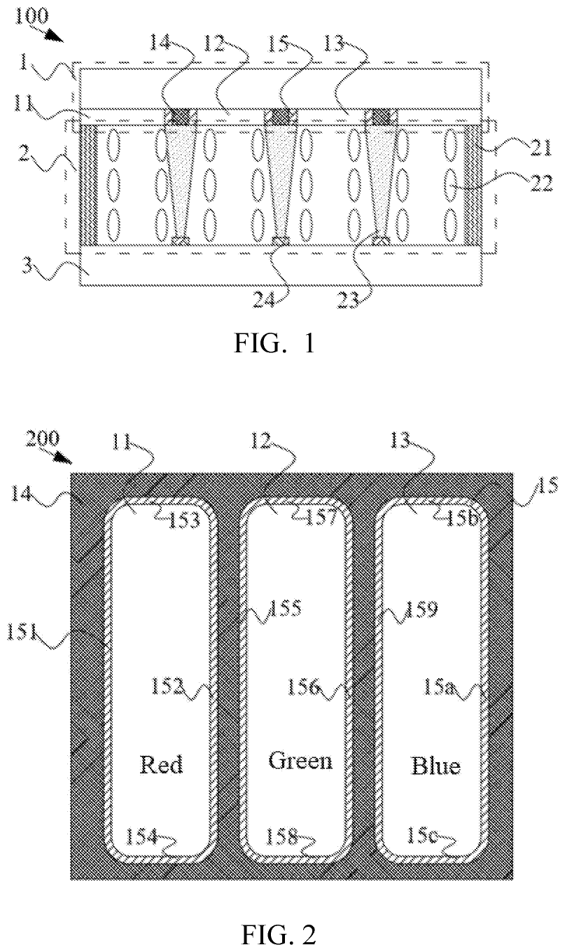

Referring to FIG. 1 to FIG. 4, a liquid crystal display panel is provided.

Referring to FIG. 1, it is a schematic view of a liquid crystal display panel 100 according to one embodiment. The liquid crystal display panel 100 includes a color filter substrate 1, an array substrate 3, and a liquid crystal layer 2. The color filter substrate 1 further includes a red color filter 11, a green color filter 12, and a blue color filter 13, a black matrix 14, and a semi-transparent region 15. The liquid crystal layer 2 further includes a sealant 21, liquid crystals 22, a spacer 23, and a spacer pad 24.

Referring to FIG. 2, it is a first structural schematic view of a color filter substrate 200 of a liquid crystal display panel according to one embodiment. The color filter substrate 200 includes a red color filter 11, a green color filter 12, and a blue color filter 13, a black matrix 14, and a semi-transparent region 15. The semi-transparent region 15 includes a first semi-transparent region 151, a second semi-transparent region 152, a third semi-transparent region 153, a fourth semi-transparent region 154, a fifth semi-transparent region 155, a sixth semi-transparent region 156, a seventh semi-transparent region 157, an eighth semi-transparent region 158, a ninth semi-transparent region 159, a tenth region semitransparent 15a, an eleventh semi-transparent region 15b, and a twelfth semi-transparent region 15c. A part between two adjacent semi-transparent regions is at a round angle.

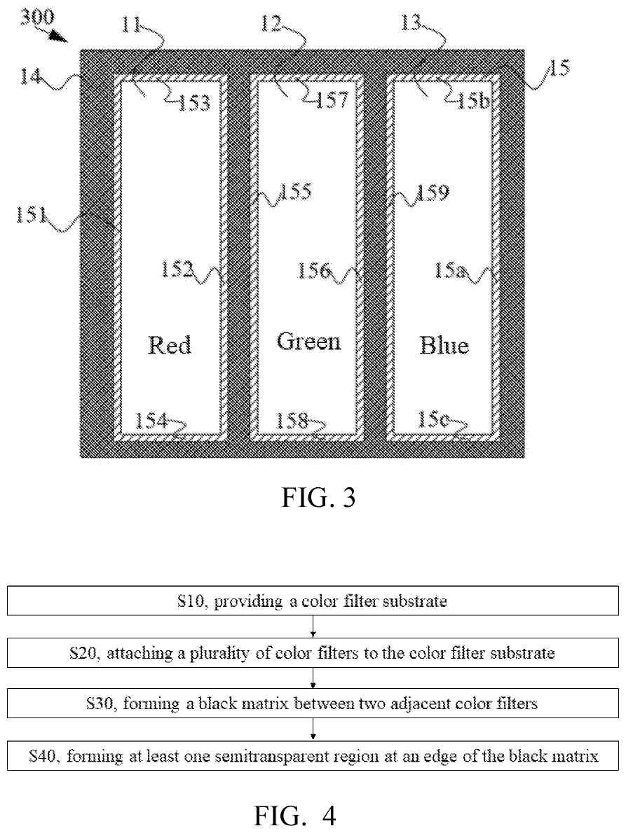

Referring to FIG. 3, it is a second structural schematic view of a color filter substrate 300 of a liquid crystal display panel according to one embodiment. FIG. 3 is similar to FIG. 2 except that a part between two adjacent semi-transparent regions is at a right angle.

In one embodiment, a liquid crystal display panel includes an array substrate, a color filter substrate, a liquid crystal layer, and a spacer. The array substrate is disposed at a bottom of the liquid crystal display panel, and the color filter substrate corresponds to the array substrate and is disposed above the liquid crystal panel, and the liquid crystal layer is disposed between the array substrate and the color filter substrate. The spacer is also disposed between the array substrate and the color filter substrate and the spacer is configured to support the array substrate and the color filter substrate. The color filter substrate is provided with at least one semi-transparent region configured to shield from light leakage when two sides of the array substrate are shifted, which reduces an aperture ratio of the liquid crystal display panel and a loss ratio of the liquid crystal display panel.

In one embodiment, a color filter substrate includes a color filter and a black matrix disposed on the color filter substrate.

In one embodiment, the color filter comprises a red color filter, a green color filter, and a blue color filter.

In one embodiment, the at least one semi-transparent region is disposed between the red color filter and the black matrix, between the green color filter and the black matrix, and between the blue color filter and the black matrix.

In one embodiment, the at least one semi-transparent region is exposed within the black matrix using a gray tone mask or a half tone mask.

In one embodiment, the at least one semi-transparent region comprises a first semi-transparent region, a second semi-transparent region, a third semi-transparent region, a fourth semi-transparent region, a fifth semi-transparent region, a sixth semi-transparent region, a seventh semi-transparent region, an eighth semi-transparent region, a ninth semi-transparent region, a tenth region, an eleventh semi-transparent region, and a twelfth semi-transparent region.

In one embodiment, the first semi-transparent region corresponds to the second semi-transparent region, the third semi-transparent region corresponds to the fourth semi-transparent region, the fifth semi-transparent region corresponds to the sixth semi-transparent region, the seventh semi-transparent region corresponds to the eighth semi-transparent region, the ninth semi-transparent region corresponds to the tenth semi-transparent region, and the eleventh semi-transparent region corresponds to the twelfth semi-transparent region.

In one embodiment, lengths, widths, and heights of the first semi-transparent region, the second semi-transparent region, the fifth semi-transparent region, the sixth semi-transparent region, the ninth semi-transparent region, and the tenth semi-transparent region are same, and lengths, widths, and heights of the third semi-transparent region, the fourth semi-transparent region, the seventh semi-transparent region, the eighth semi-transparent region, the eleventh semi-transparent region, and the twelfth semi-transparent region are same.

In one embodiment, a thickness of the at least one semi-transparent region is less than a thickness of the black matrix, and a width of the at least one semi-transparent region is greater than, less than, or equal to a width of the black matrix.

In one embodiment, a part between the black matrix and the at least one semi-transparent region is at a round angle or a right angle.

In one embodiment, the liquid crystal display panel further includes a sealant.

In one embodiment, the sealant is disposed between the array substrate and the color filter substrate, outside the liquid crystal layer, and a periphery of the liquid crystal display panel.

In one embodiment, the liquid crystal display panel further ??? a spacer pad.

In one embodiment, the spacer pad is disposed under the spacer and above the array substrate. The spacer pad is configured to support the spacer and prevents scratching of the array substrate by the spacer.

Referring to FIG. 4, which is a schematic flowchart of a method of manufacturing a liquid crystal display panel for improving moire according to one embodiment.

The method of manufacturing the liquid crystal display panel for improving moire includes following steps: S10, providing a color filter substrate; S20, attaching a plurality of color filters to the color filter substrate; S30, forming a black matrix between two adjacent color filters; and S40, forming at least one semi-transparent region at an edge of the black matrix.

In one embodiment, in the step S20, the color filter includes a red color filter, a green color filter, and a blue color filter.

In one embodiment, the two adjacent color filters have different colors, that is, different color filters are interlaced with each other.

The liquid crystal display panel provided by the embodiments is described in detail above. The present application has been described in the above preferred embodiments, but the preferred embodiments are not intended to limit the scope of the invention, and a person skilled in the art may make various modifications without departing from the spirit and scope of the application. The scope of the present application is determined by claims.

What is claimed is:

1. A liquid crystal display panel, comprising:
an array substrate, a color filter substrate, a liquid crystal layer, a spacer, and a spacer pad;
wherein the array substrate is disposed at a bottom of the liquid crystal display panel, and the color filter substrate corresponds to the array substrate and is disposed above the liquid crystal panel, and the liquid crystal layer is disposed between the array substrate and the color filter substrate;
wherein the spacer is also disposed between the array substrate and the color filter substrate and the spacer is configured to support the array substrate and the color filter substrate; and
wherein the color filter substrate is provided with at least one semi-transparent region configured to shield from light leakage when two sides of the array substrate are shifted, which reduces an aperture ratio of the liquid crystal display panel and a loss ratio of the liquid crystal display panel.

2. The liquid crystal display panel according to claim 1, further comprising a color filter and a black matrix disposed on the color filter substrate.

3. The liquid crystal display panel according to claim 2, wherein the color filter comprises a red color filter, a green color filter, and a blue color filter.

4. The liquid crystal display panel according to claim 2, wherein the at least one semi-transparent region is disposed between the red color filter and the black matrix, between the green color filter and the black matrix, and between the blue color filter and the black matrix.

5. The liquid crystal display panel according to claim 4, wherein the at least one semi-transparent region is exposed within the black matrix using a gray tone mask or a half tone mask.

6. The liquid crystal display panel according to claim 1, further comprising a sealant.

7. The liquid crystal display panel according to claim 6, wherein the sealant is disposed between the array substrate and the color filter substrate, outside the liquid crystal layer, and a periphery of the liquid crystal display panel.

8. The liquid crystal display panel according to claim 1, wherein the spacer pad is disposed under the spacer and above the array substrate.

9. A liquid crystal display panel, comprising:
an array substrate, a color filter substrate, a liquid crystal layer, and a spacer;
wherein the array substrate is disposed at a bottom of the liquid crystal display panel, and the color filter substrate corresponds to the array substrate and is disposed above the liquid crystal panel, and the liquid crystal layer is disposed between the array substrate and the color filter substrate;
wherein the spacer is also disposed between the array substrate and the color filter substrate and the spacer is configured to support the array substrate and the color filter substrate; and
wherein the color filter substrate is provided with at least one semi-transparent region configured to shield from light leakage when two sides of the array substrate are shifted, which reduces an aperture ratio of the liquid crystal display panel and a loss ratio of the liquid crystal display panel.

10. The liquid crystal display panel according to claim 9, further comprising a color filter and a black matrix disposed on the color filter substrate.

11. The liquid crystal display panel according to claim 10, wherein the color filter comprises a red color filter, a green color filter, and a blue color filter.

12. The liquid crystal display panel according to claim 10, wherein the at least one semi-transparent region is disposed between the red color filter and the black matrix, between the green color filter and the black matrix, and between the blue color filter and the black matrix.

13. The liquid crystal display panel according to claim 12, wherein the at least one semi-transparent region is exposed within the black matrix using a gray tone mask or a half tone mask.

14. The liquid crystal display panel according to claim 12, wherein the at least one semi-transparent region comprises a first semi-transparent region, a second semi-transparent region, a third semi-transparent region, a fourth semi-transparent region, a fifth semi-transparent region, a sixth semi-transparent region, a seventh semi-transparent region, an eighth semi-transparent region, a ninth semi-transparent region, a tenth region semitransparent, an eleventh semi-transparent region, and a twelfth semi-transparent region.

15. The liquid crystal display panel according to claim 14, wherein the first semi-transparent region corresponds to the second semi-transparent region, the third semi-transparent region corresponds to the fourth semi-transparent region, the fifth semi-transparent region corresponds to the sixth semi-transparent region, the seventh semi-transparent region corresponds to the eighth semi-transparent region, the ninth semi-transparent region corresponds to the tenth semi-transparent region, and the eleventh semi-transparent region corresponds to the twelfth semi-transparent region.

16. The liquid crystal display panel according to claim 15, wherein lengths, widths, and heights of the first semi-transparent region, the second semi-transparent region, the fifth semi-transparent region, the sixth semi-transparent region, the ninth semi-transparent region, and the tenth semi-transparent region are same, and lengths, widths, and heights of the third semi-transparent region, the fourth semi-transparent region, the seventh semi-transparent region, the eighth semi-transparent region, the eleventh semi-transparent region, and the twelfth semi-transparent region are same.

17. The liquid crystal display panel according to claim 10, wherein a thickness of the at least one semi-transparent region is less than a thickness of the black matrix, and a width of the at least one semi-transparent region is greater than, less than, or equal to a width of the black matrix.

18. The liquid crystal display panel according to claim 17, wherein a part between the black matrix and the at least one semi-transparent region is at a round angle or a right angle.

19. A method of manufacturing a liquid crystal display panel for improving moire, comprising:
S10, providing a color filter substrate;
S20, attaching a plurality of color filters to the color filter substrate;
S30, forming a black matrix between two adjacent color filters; and
S40, forming at least one semi-transparent region at an edge of the black matrix.

20. The method of manufacturing the liquid crystal display panel according to claim 19, wherein the two adjacent color filters have different colors.
